(19) United States
(12) Patent Application Publication
(10) Pub. No.: US 2026/0321804 A1
(43) Pub. Date: Oct. 15, 2026

(54) MECHAGENIC ENERGY SYSTEM

(71) Applicant: THE TRUSTEES OF THE UNIVERSITY OF PENNSYLVANIA, Philadelphia, PA (US)

(72) Inventors: James Henry PIKUL, Philadelphia, PA (US); Yue GAO, Shanghai (CN)

(21) Appl. No.: 19/484,012

(22) PCT Filed: May 16, 2024
(86) PCT No.: PCT/US2024/029642

§ 371 Date: Nov. 13, 2025

Related U.S. Application Data
(60) Provisional application No. 63/502,442, filed on May 16, 2023.

(51) Int. Cl. H01M 12/08; H01M 4/38; H01M 8/18

(52) U.S. Cl. CPC H01M 12/08; H01M 4/382; H01M 8/188; H01M 2220/20

(57) ABSTRACT

Disclosed is an electrochemical system that includes a refillable cell; a catholyte, the catholyte optionally being ionically conductive, and the catholyte optionally comprising at least one of dimethyl disulfide and dimethyl trisulfide; a metallic anode, the metallic anode optionally comprising Li; a cathode current collector configured to contact the catholyte; a poly meric separator disposed to separate the cathode current collector and the metallic anode; and optionally, a binder, and wherein the refillable cell is configured to contact the catholyte and the metallic anode so as to evolve current that is collected by the cathode current collector and to evolve a metallic reaction product, the metallic reaction product comprising a metal of the metallic anode and the metallic reaction product optionally being soluble in the catholyte, and wherein the refillable cell has an inlet configured to receive catholyte and has an outlet configured to communicate therefrom an output that comprises the metallic reaction product.

### CROSS-REFERENCE TO RELATED APPLICATIONS

The present application claims priority to and the benefit of U.S. patent application No. 63/502,442, “Mechagenic Energy System” (filed May 16, 2023). All foregoing applications are incorporated herein by reference in their entireties for any and all purposes.

### TECHNICAL FIELD

The disclosed technology relates to the field of mobile energy generation.

### BACKGROUND

Aviation, long-distance transport, and shipping represent 6% of global CO2 emissions, but electrifying these fleets requires significant improvements in battery energy and power density. Mass-produced rechargeable batteries have energy densities below 250 Wh kg⁻¹ while short-range all-electric aircraft require 750-2,000 Wh kg⁻¹. In addition, batteries should rapidly recharge at high power density to allow aircraft to operate near-continuously and offset their high sunk costs. Battery chemistries that utilize conversion reactions, such as Li-sulfur and Li-air, can exceed 750 Wh kg⁻¹, however they have fundamental problems in realizing their high theoretical energy density, poor power capability, and short cycle life.

Net-zero emission liquid fuels are an alternative to batteries that can be rapidly refilled for near-continuous operation, but they require complex and expensive fuel cells to provide electrical power and, unlike a battery which can be used multiple times, the fuel is consumed. These challenges inspire alternative electrical power sources that can be rapidly refilled like a fuel, recharged like a battery, and achieve the energy and power density requirements of vehicle fleets for continuous operation.

### SUMMARY

In meeting the described long-felt needs, the present disclosure provides an electrochemical system, comprising: a refillable cell; a catholyte, the catholyte optionally being ionically conductive, and the catholyte optionally comprising at least one of dimethyl disulfide and dimethyl trisulfide; a metallic anode, the metallic anode optionally comprising Li; a cathode current collector configured to contact the catholyte; a polymeric separator disposed to separate the cathode current collector and the metallic anode; and optionally, a binder, and wherein the refillable cell is configured to contact the catholyte and the metallic anode so as to evolve current that is collected by the cathode current collector and to evolve a metallic reaction product, the metallic reaction product comprising a metal of the metallic anode and the metallic reaction product optionally being soluble in the catholyte, and wherein the refillable cell has an inlet configured to receive catholyte and has an outlet configured to communicate therefrom an output that comprises the metallic reaction product.

Also provided is a method, comprising: in a refillable cell, contacting (a) a catholyte and (b) a metallic anode under conditions sufficient to at least partially consume the metallic anode, evolve a current, and evolve a metallic reaction product, the metallic reaction product comprising a metal of the metallic anode and the metallic reaction product optionally being soluble in the catholyte, the catholyte optionally comprising at least one of dimethyl disulfide and trimethyl disulfide, and the metallic anode optionally comprising Li; and collecting the current. One can collect the current, for example, to power a device or other load.

Further provided is a method, comprising: in a refillable cell, contacting (a) a catholyte that comprises dimethyl disulfide or dimethyl trisulfide, and (b) a Li anode so as to at least partially consume the Li anode, evolve a current, and evolve a reaction product comprising Li; collecting the current; and any one or more of (i) refilling the cell with catholyte, (ii) replacing the Li anode of the cell, and (iii) collecting catholyte from the cell.

Additionally provided is an electrochemical system, comprising: a refillable cell; a catholyte that comprises dimethyl disulfide or dimethyl trisulfide, a Li anode; a current collector; a polymeric separator disposed to separate the current collector and the anode; the refillable cell configured to contact the catholyte and the metal anode such that evolved current is collected by the current collector, and the refillable cell having an inlet configured to receive catholyte and having an outlet configured to communicate at least a product evolved from contacting the catholyte and the Li anode.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1a-1g: An example electrochemical stomach that provides continuous or near-continuous power. a, Illustration of a stomach-powered robotic dog that ingests the energy-dense organic small molecules as beverages and converts that chemical energy to electricity. b, c, The structure (c) and assembly (d) of a stomach that consists of a carbon current collector, a porous polymer separator, a Li metal anode, and the case. During discharge, the energy-dense organic small molecule, CH3S3CH3, is electrochemically reduced to CH3SLi and Li2S. The discharge products are soluble and can be ejected at the outlet. d, Photographs showing a 77-second digestion in a stomach-powered toy robotic dog. The dog ingests a beverage delivered manually (or at an automatic supply station). A new beverage is ingested while the consumed beverage is ejected. No special environmental conditions are required. e, Discharge curves of the stomach with constant currents of 52.6 and 10.5 A kg−1, with corresponding specific capacities of 828.9 and 841.7 mAh g−1 based on CH3S3CH3 weight. Both capacities are close to the theoretical value of 848.8 mAh g−1. f, Stomach capacities and the beverage mass added to the stomach during five consecutive reingestions and discharges of the stomach. A single Li source was used. g, An energy density comparison of the stomach to leading battery technologies, including Li metal, Li-ion, and Li-polysulfide flow systems. The stomach has an energy density of up to 850 Wh kg−1, much higher than commercial Li-ion batteries (~250 Wh kg−1).

FIGS. 2a-2k: Electrochemical process in the stomach. a,b, Scanning electron microscope (SEM) images of the pristine CNT foam (a) and the foam after ejecting used catholyte (b). The CNT foam pore structure was retained after the reingestion process, and no solids were found on the CNT surface. c, SEM image of CH3SLi and Li2S deposited on the carbon felt surface of a control cathode current collector. d, Rate performance of the stomach. With current densities of 32 to 192 A kg−1, the stomach delivered at least 1 V output. e, The conversion of CH3S3CH3 monitored by 1H NMR. During discharge, the peaks (2.4 ppm) of CH3S3CH3 decreased gradually and disappeared at 100% DoD, along with the appearance of CH3Sli (peaks at 1.8 ppm). f,g, SEM images of the Li electrodes after dissolving 19.4 mAh cm−2 (g) and 77.7 mAh cm−2 (g) of Li. h, Corresponding XPS spectra of the Li electrodes in f (red) and g (blue). The SEI showed consistent chemical compositions, suggesting a stable interface. i, Stomach capacities that can be tuned by adding different amounts of beverages. j, Voltage profile of the stomach operated at −20 □C. The capacity was 818 mAh g−1 and the potential was ~1.8 V. k, The voltage profile of the stomach with a catholyte stored for 3.2 years. The capacity was 826 mAh g-1.

FIG. 3a-3f: Stomach design and electrochemical performance. A,b, Photographs of a stomach (a) and its interior structure. We can design multiple cells in parallel or series to provide different voltage and current outputs (b). c, A phantom view of the stomach that allows liquid ingestion and ejection using a single inlet and outlet. D,e, The inlet (d) and outlet € design is compatible with the toy robot dog. F, The 5 consecutive discharge curves of the stomach, corresponding to FIG. 1f.

FIG. 4a-4i: Discharge process and Li surface stability in the stomach. a,b, The SEM image (a) and photograph (b) of the pristine CNT foam. c, The SEM image of the CNT foam after an acid cleaning process. The CNT surface is clean, and the pore structure was retained. d, The SEM image of the CNT foam used in a control electrolyte, 1 M LiTFSI in DOL-DME (1:1 in the molar ratio). CH3SLi and Li2S are almost insoluble in the control electrolyte and thus were precipitated on the CNT surface. e, Discharge curves of the stomach with a control electrolyte and a control carbon felt current collector, respectively. f, 1H NMR spectra of CH3S3CH3 and the supporting electrolyte. g, Depth-profiling XPS spectra of the Li electrodes after 1st and 4th use, corresponding to the areal capacities of 19.4 and 77.7 mAh cm−2. The SEI thicknesses are consistent, evidenced by the similar sputtering time to reach out the Li metal layer (peaks at ~53 eV in the Li 1s spectra). The sputtering rate based on SiO2 is 10 nm min−1. h, The SEM image of the Li electrode after Li dissolution with a current density of 64 A kg−1. i, S 2p XPS spectra of the Li electrodes after 1st use and the same piece of the electrode immersed in the beverage for 24 hours. No CH3SLi and Li2S were found on the Li surface, suggesting an effectively protected Li metal electrode.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

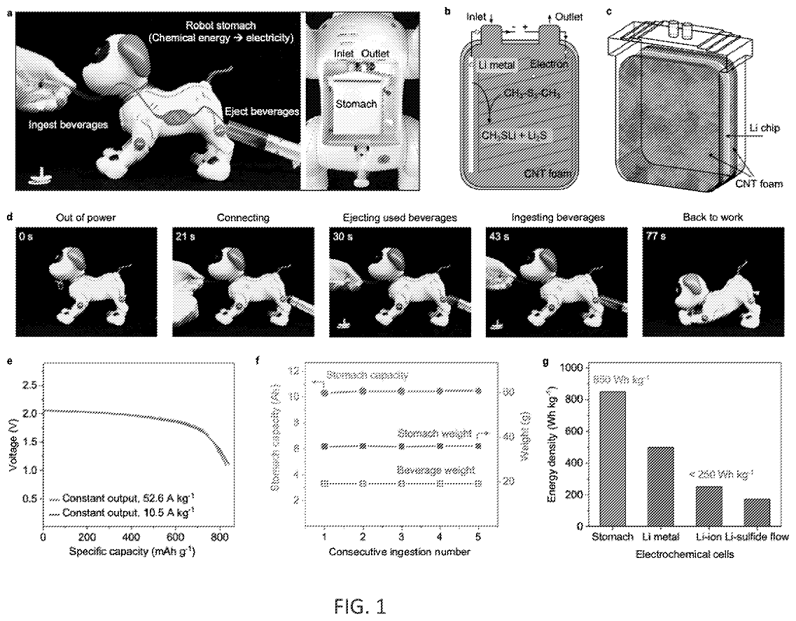

Described here are electrochemical systems that allows rapid refilling by ingesting a liquid or solid as a beverage or food, have the discharge energy and power densities for electric aircraft and robots, and can be recycled and reused for many cycles. The disclosed solution develops redox-active organic small molecules, for example dimethyl trisulfide (CH₃S₃CH₃), stored in a liquid catholyte as a beverage and pairs it with metal anodes in an ingestible electrochemical cell, which we refer to as a stomach (FIG. 1a). We demonstrated the stomach in a toy robot dog; a 10.4 Ah stomach with CH₃S₃CH₃ and Li achieved an energy density of 850 Wh kg_{stomach}⁻¹. The beverage had a 3.2-year storage life and delivered 98% of its room temperature capacity at −20 °C. We developed a current collector and altered the beverage composition to achieve a current output of 193.5 A kg_{stomach}⁻¹ by promoting CH₃S₃CH₃ transport and preventing electrode polarization, which plagued prior organosulfur chemistries. Unlike fuels in engines and fuel cells, the beverage and Li are recyclable with electrical input and can be used again in the stomach in what we refer to as a mechagenic cycle. The stomach is cost-efficient relative to rechargeable batteries and gasoline.

The liquid beverage can enable rapid ingestion of the stomach and remain liquid after reduction for facile ejecting of the discharged products. A high capacity and fast kinetics are required as well. To enhance energy density, we paired solid metal anodes with the beverage. These anodes can be, for example, be introduced to the stomach as slurries, or mechanically inserted after multiple discharges. A robot can, therefore, opportunistically drink (replacing the beverage) and occasionally eat (replacing the solid anode) to achieve near-continuous operation.

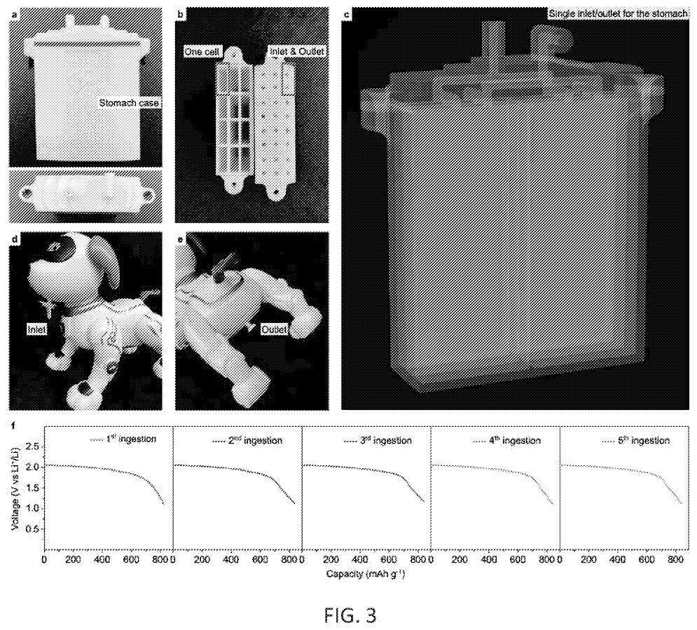

Following this idea, we designed a beverage containing CH₃S₃CH₃ with a theoretical capacity of 848.8 mAh g−1 and a supporting electrolyte of 1 M lithium bis(trifluoromethane sulfonyl) imide (LiTFSI) in dioxolane (DOL)-dimethoxyethane (DME)-caprolactam-acetamide (2:2:3:3 in the molar ratio) with 4 wt % lithium nitrate. An example stomach included of a carbon nanotube (CNT) foam current collector for the beverage, a polymer separator, a metallic Li electrode, and a plastic case with a beverage inlet and outlet (FIG. 1b and FIG. 3a-3e). The CNT foam, separator, and Li electrode were stacked in the stomach (FIG. 1c). The discharge products, lithium methoxide (CH₃SLi) and lithium sulfide (Li₂S), were made soluble in the beverage and, therefore, easily ejected from the robot dog with a simple flushing process. It took 77 seconds for a robot dog to recognize a supply station, manually connect to a liquid inlet and outlet, eject discharged beverages, and ingest fresh beverages. This process took place in ambient air without the need for special gases.

At output current densities of 52.6 and 10.5 A kg_{stoamch}⁻¹, the stomach delivered specific capacities of 828.9 and 841.7 mAh gCH₃S₃CH₃⁻¹ (FIG. 1e). The discharge voltages are ~2 V. We next examined the capability for continuous operation of a 10.4 Ah stomach by ingesting it with the beverage five times. 55.3 Ah of Li was pre-installed in the stomach to accommodate the 5 discharges, and 19.0 g of the beverage was added (and used beverage ejected) to the stomach for each discharge. The dry components of the stomach without the case were 16.8 g. Each of the 5 discharge curves consistently delivered ~10.4 Ah and 2 V (FIG. 1f and FIG. 3f). 850 Wh kg_{stomach}⁻¹ was the highest single-discharge energy density achieved, where kg_{stomach}⁻¹ includes all components except the case (FIG. 1f and FIG. 3f). In comparison, the energy densities of commercial Li-ion, future Li-metal, and Li-sulfide flow batteries are below 250, 500, and 170 Wh kg⁻¹, respectively¹⁵⁻¹⁷. The stomach can improve the energy density of the full quadcopter from 250 kJ kg⁻¹ to ~650 kJ kg⁻¹.

### Liquid-State Electrochemistry

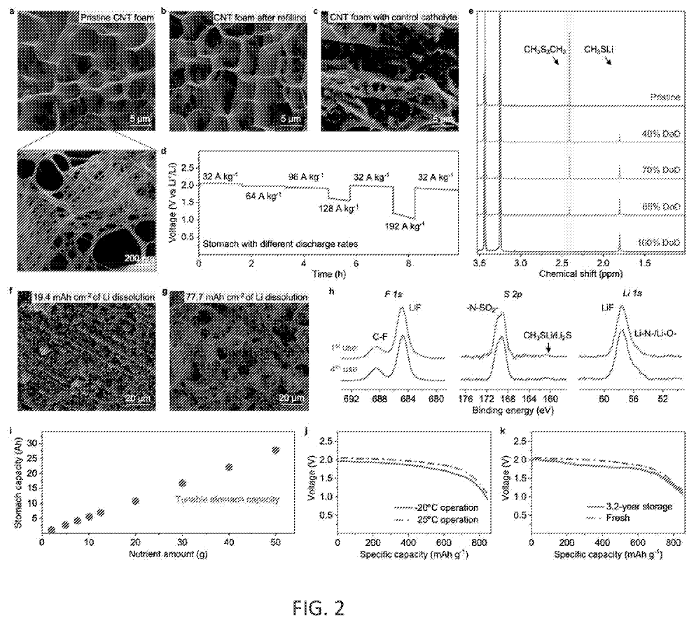

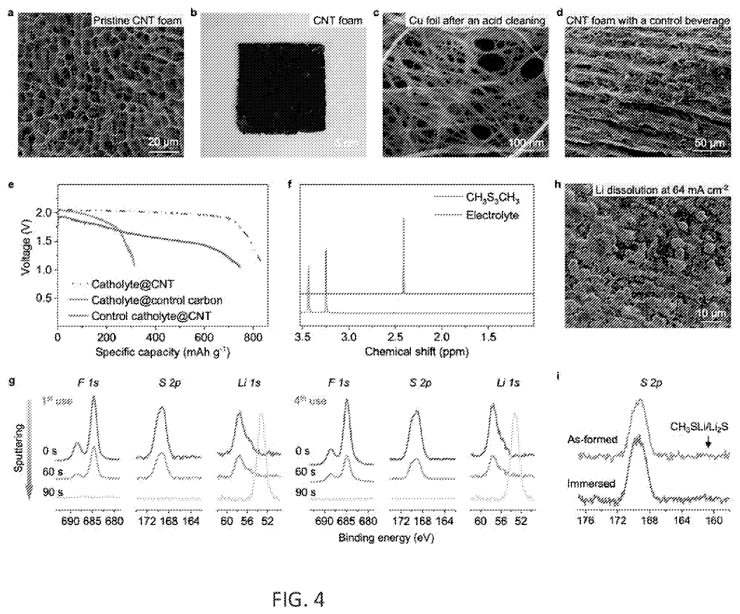

In addition to the fast kinetics of CH₃S₃CH₃, the use of CNT foam current collectors and dissolution of the discharged products in the catholyte are essential for the high-energy-density and high-rate capability of the stomach. The CNT foam with micro-and nanopores has a high surface area of 770 m² g⁻¹, which provides sufficient surface sites for a liquid-state reduction of CH₃S₃CH₃ (FIG. 2a and FIG. 4a-b). The pore structure of the CNT foam was retained after discharge, and no solid discharge products were seen at the CNT surface after reingestion (FIG. 2b and FIG. 4c). We also tested a control catholyte incapable of dissolving the discharge products, and found massive CH₃Li and Li₂S build-up on the CNT surface (FIG. 2c and FIG. 4d), which is also correlated with severe polarization of the discharge curve (FIG. 4e). We verified a good rate capability of the stomach by applying increasing current densities in 8-hour increments from 32 to 192 A kg_{stoamch}⁻¹. The output voltages were always above 1 V from 0% to 100% degree of discharge (DoD) (FIG. 2d), which is important for high-power applications such as aircraft taking off and landing. We reasoned that the micropores (smaller than 20 μm) of the CNT foam maintain a small diffusion distance and rapid mass transport to reaction sites. This is also evidenced by the huge polarization for a control current collector of carbon felt with 580 μm pores (FIG. 4e). The high conversion rate of the discharge reaction was confirmed by monitoring the ¹H NMR spectra of the beverage along discharge (FIG. 2e and FIG. 4f). CH₃S₃CH₃ signals (peaks at 2.4 ppm) were found in the pristine beverage, decreased upon discharge, and became invisible at 100% DoD. This is accompanied by the appearance of CH₃SLi signals (peaks at 1.8ppm)¹⁸.

Another key to the successful operation of the stomach is to stably dissolve Li metal. Owing to the addition of lithium nitrate and ether solvents in the beverage, a passive solid-electrolyte interphase (SEI) was formed on the Li surface to minimize Li-beverage reactions. No CH₃SLi and Li₂S were found on the Li surface when we immersed a Li electrode in the catholyte for 24 hours (FIG. 4g). At a current density of 32 A kg_{stoamch}⁻¹, the Li electrodes showed flat morphologies after the 1^{st} (FIGS. 2f) and 4^{th} use (FIG. 2g), corresponding to the areal capacities of 19.4 and 77.7 mAh cm⁻². A similar phenomenon was seen when the current density was elevated to 64 A kg⁻¹. Meanwhile, the SEI layers had consistent chemical composition (FIG. 3h) and thickness (FIG. 4i) upon discharge, suggesting good interfacial stability. Specifically, LiF and Li—N— salts are the dominant salts in the SEI, and no CH₃SLi and Li₂S were seen. A detailed peak interpretation is as follows: peaks at 688.5 and 684.9 eV in the F 1s spectrum are attributed to C—F and LiF; split peaks at 169.9 and 168.7 eV in the S 2p spectrum are assigned to —NSO₂—; peaks at 57.6 and 55.5 eV in the Li 1s spectrum are assigned to Li—F and Li—N—/Li—O—, respectively 19,20.

Owing to the liquid-state electrochemistry, the stomach allows facile tuning of capacity based on different workloads (FIG. 2i), so that only the necessary mass needs to be carried. The stomach was also operated at −20 °C and had a specific capacity of 818.6 mAh gCH3S3CH3−1 and a voltage of ~1.8 V (FIG. 2j). The catholyte has a long hermetic storage life, delivering a specific capacity of 826.8 mAh gCH3S3CH3−1 after 3.2 years of storage in an argon atmosphere (FIG. 2k).

### Methods

### Preparation of the Beverage and CNT Foam

To prepare the beverage, we first mixed caprolactam and acetamide and heated the mixture to 60 °C to get a clear solution. A DOL-DME solution of LiTFSI was then added to the solution. Lithium nitrate was added afterward. The solution was stirred 4 hours before use. The beverage was prepared and stored in an argon-filled glovebox. To prepare the CNT foam current collector, an aqueous solution of 0.4 wt % single wall CNT (OCSiAl) with 0.04 wt % carboxymethyl cellulose was poured into a polytetrafluoroethylene mold with designed dimensions and immediately froze in the liquid nitrogen. The sample was then freeze-dried²². An aluminum tab was attached when used as the current collector.

### Stomach Operation and Reingestion

The CNT foam current collector and Li metal on Cu foil were stacked in a layer-by-layer way and separated by Celgard 2325 membranes. The beverage was filled into the stomach before the operation and can be easily removed when not in use. To reingest 20 ml beverage, we injected ~20 ml air into the chamber and then flushed the chamber using another 20 ml beverage 2 times. The stomach can be divided into multiple chambers to make cells in parallel or series to provide various voltage and current outputs. The inlet and outlet were sealed by caps during stomach operations. The stomach case was 3D printed using a commercial organic resistant resin and the case was sealed by a polymer gasket. The case design is for demonstration purposes and can be further optimized for practical applications. For the toy robot dog demonstration, the stomach was placed inside the body of the commercial robot dog, and the inlet and outlet were connected with the mouth and tail, respectively, using plastic tubes. Electrochemical testing conditions The stomachs were discharged to 1.0 V at the galvanostatic condition using a CHI 660 electrochemical workstation. After ingestion, the stomach was held for 1 minute before discharge. We mimicked dynamic scenarios by testing the stomach on a circumferential shaker (TOS-200, Titan) with a speed of 50 rpm. The low-temperature test was performed in an environmental test chamber. 1 M lithium hexafluorophosphate (LiPF₆) in ethylene carbonate (EC)-ethyl methyl carbonate (EMC)-vinylene carbonate (VC) (3:6:1 in the volume ratio) electrolyte was employed in the stomach that contains 1,4-benzoquinone and Li. The aqueous stomach of 1,4-benzoquinone and Zn contains a 3 M zinc sulfate aqueous electrolyte. 1 M lithium tetrachloroaluminate in thionyl chloride was employed as the beverage for the energy-dense stomach using thionyl chloride and Li. The stomach incorporating dimethyl disulfide and Mg has used a 0.4 M magnesium tetrakis(hexafluoroisopropyloxy) borate in DME electrolyte²³.

### Characterization

XPS analysis was conducted on a PHI VersaProbe II Scanning XPS Microprobe. A 20 eV argon ion beam was used for the depth profiling experiments. The XPS samples were loaded in an argon-filled glovebox and transferred to the instrument through a vacuum transfer vessel. The SEM images were captured on a Zeiss Ultra 55 instrument. The XPS and SEM samples were washed with DOL solvents 3 times to remove the beverage residue and dried under a vacuum. The NMR experiments were performed on a Bruker AVANCE III HD 400 MHz. The samples were directly collected from the stomach at different degrees of discharge and mixed with deuterated dimethyl sulfoxide solvent. The volume ratio is 1:1.

### REFERENCES

1. Schäfer, A. W. et al. Technological, economic and environmental prospects of all-electric aircraft. Nat Energy 4, 160-166 (2019).
2. Dray, L. et al. Cost and emissions pathways towards net-zero climate impacts in aviation. Nat Clim Chang 12, 956-962 (2022).
3. Tarascon, J. M. & Armand, M. Issues and challenges facing rechargeable lithium batteries. Nature 414, 359-67 (2001).
4. Bruce, P. G., Freunberger, S. a., Hardwick, L. J. & Tarascon, J.-M. Li—O2 and Li—S batteries with high energy storage. Nat Mater 11, 172-172 (2011).
5. Choi, J. W. & Aurbach, D. Promise and reality of post-lithium-ion batteries with high energy densities. Nat Rev Mater 1, 16013 (2016).
6. Fredericks, W. L., Sripad, S., Bower, G. C. & Viswanathan, V. Performance Metrics Required of Next-Generation Batteries to Electrify Vertical Takeoff and Landing (VTOL) Aircraft. ACS Energy Letters vol. 3 2989-2997 (2018).
7. Yang, X. G., Liu, T., Ge, S., Rountree, E. & Wang, C. Y. Challenges and key requirements of batteries for electric vertical takeoff and landing aircraft. Joule vol. 5 1644-1659 (2021).
8. Liu, Y., Zhu, Y. & Cui, Y. Challenges and opportunities towards fast-charging battery materials. Nat Energy 4, 540-550 (2019).
9. Aubin, C. A. et al. Electrolytic vascular systems for energy-dense robots. Nature 571, 51-57 (2019).
10. Yu, J. et al. A class of liquid anode for rechargeable batteries with ultralong cycle life. Nat Commun 8, (2017).
11. Li, S. et al. A Semiliquid Lithium Metal Anode. Joule 3, 1637-1646 (2019).
12. Yang, Z. et al. A Semi-solid Zinc Powder-based Slurry Anode for Advanced Aqueous Zinc-ion Batteries. Angewandte Chemie—International Edition 62, (2023).
13. Cheng, Q. et al. Full Dissolution of the Whole Lithium Sulfide Family (Li 2 S 8 to Li 2 S) in a Safe Eutectic Solvent for Rechargeable Lithium-Sulfur Batteries. Angewandte Chemie 131, 5613-5617 (2019).
14. Hu, Y., Li, H., Huang, X. & Chen, L. Novel room temperature molten salt electrolyte based on LiTFSI and acetamide for lithium batteries. Electrochem commun 6, 28-32 (2004).
15. Wang, D. Y., Guo, W. & Fu, Y. Organosulfides: An Emerging Class of Cathode Materials for Rechargeable Lithium Batteries. Acc Chem Res 52, 2290-2300 (2019).
16. Yang, Y., Zheng, G. & Cui, Y. A membrane-free lithium/polysulfide semi-liquid battery for large-scale energy storage. Energy Environ Sci 6, 1552-1558 (2013).

17. Li, Z. & Lu, Y. C. Polysulfide-based redox flow batteries with long life and low levelized cost enabled by charge-reinforced ion-selective membranes. Nat Energy 6, 517-528 (2021).

18. Chen, S. et al. Functional Organosulfide Electrolyte Promotes an Alternate Reaction Pathway to Achieve High Performance in Lithium-Sulfur Batteries. Angewandte Chemie International Edition 55, 4231-4235 (2016).
19. Gao, Y. et al. Polymer-inorganic solid-electrolyte interphase for stable lithium metal batteries under lean electrolyte conditions. Nat Mater 18, 384-389 (2019).
20. Gao, Y. et al. Salt-Based Organic-Inorganic Nanocomposites: Towards A Stable Lithium Metal/Li 10 GeP 2 S 12 Solid Electrolyte Interface. Angewandte Chemie International Edition 57, 13608-13612 (2018).
21. Wang, Y., Wang, Y. & Zhou, H. A Li-liquid cathode battery based on a hybrid electrolyte. ChemSusChem 4, 1087-1090 (2011).
22. Thongprachan, N., Nakagawa, K., Sano, N., Charinpanitkul, T. & Tanthapanichakoon, W. Preparation of macroporous solid foam from multi-walled carbon nanotubes by freeze-drying technique. Mater Chem Phys 112, 262-269 (2008).
23. Zhao-Karger, Z., Gil Bardaji, M. E., Fuhr, O. & Fichtner, M. A new class of non-corrosive, highly efficient electrolytes for rechargeable magnesium batteries. J Mater Chem A Mater 5, 10815-10820 (2017).
24. Guo, Y. et al. Leaching lithium from the anode electrode materials of spent lithium-ion batteries by hydrochloric acid (HCl). Waste Management 51, 227-233 (2016).

### ASPECTS

The following Aspects are illustrative only and do not limit the scope of the present disclosure or the appended claims. Any part or parts of any one or more Aspects can be combined with any part or parts of any one or more other Aspects.

Aspect 1. A method, comprising:
in a refillable cell, contacting (a) a catholyte that comprises dimethyl disulfide or dimethyl trisulfide, and (b) a Li anode so as to at least partially consume the Li anode, evolve a current, and evolve a reaction product comprising Li;
collecting the current; and
any one or more of (i) refilling the cell with catholyte, (ii) replacing the Li anode of the cell, and (iii) collecting catholyte from the cell.

Aspect 2. The method of Aspect 1, comprising refilling the cell with catholyte.

Aspect 3. The method of any one of Aspects 1-2, wherein the refilling is performed in a continuous manner.

Aspect 4. The method of any one of Aspects 2-3, further comprising draining the cell of catholyte before refilling the cell. The cell can be completely drained of catholyte before refilling.

Aspect 5. The method of any one of Aspects 1-4, further comprising collecting catholyte from the cell while refilling the cell with catholyte.

Aspect 6. The method of any one of Aspects 2-4, wherein the refilling is performed in a batch manner.

Aspect 7. The method of any one of Aspects 1-5, wherein the metal anode is in particulate form.

Aspect 8. The method of any one of Aspects 1-6, wherein the catholyte comprises dimethyl trisulfide.

Aspect 9. The method of any one of Aspects 1-7, further comprising recharging catholyte collected from the cell. Recharged catholyte can then be introduced to the cell or to a different cell; recharging catholyte can also restore Li from reaction product solubilized in the reaction product, making that Li available for further use, for example as use in an anode of a cell according to the present disclosure.

Aspect 10. The method of any one of Aspects 1-9, wherein the reaction product is soluble in the catholyte.

Aspect 11. The method of Aspect 10, further comprising collecting from the refillable cell catholyte having the reaction product solubilized therein. As mentioned,

Aspect 12. The method of Aspect 11, further comprising recharging catholyte having the reaction product solubilized therein collected from the cell so as to give rise to recharged catholyte and Li. Recharged catholyte and/or Li can then be introduced to the cell or to a different cell; the Li can be used in an anode according to the present disclosure.

Aspect 13. The method of any one of Aspects 1-12, wherein the method is performed so as to power a vehicle or power a mobile device in which the refillable cell is comprised, the mobile device optionally being self-propelled. A vehicle can be sized to transport a person or other passenger, but this is not a requirement. Likewise, a mobile device can be a robot but does not need to be sized to accommodate a passenger.

Aspect 14. An electrochemical system, comprising: a refillable cell; a catholyte that comprises dimethyl disulfide or dimethyl trisulfide, a Li anode; a current collector; a polymeric separator disposed to separate the current collector and the anode; the refillable cell configured to contact the catholyte and the metal anode such that evolved current is collected by the current collector, and the refillable cell having an inlet configured to receive catholyte and having an outlet configured to communicate at least a product evolved from contacting the catholyte and the Li anode.

Aspect 15. The electrochemical system of Aspect 14, wherein (a) the catholyte comprises one of dimethyl trisulfide and dimethyl disulfide.

Aspect 16. The electrochemical system of any one of Aspects 14-15, wherein the electrochemical system is comprised in a mobile device powered by the electrochemical system, the mobile device optionally being self-propelled.

Aspect 17. The electrochemical system of any one of Aspects 14-16, wherein the electrochemical system is configured for continuous refilling of catholyte.

Aspect 18. The electrochemical system of any one of Aspects 14-17, wherein the electrochemical system is configured for batch refilling of catholyte.

Aspect 19. The electrochemical system of any one of Aspects 14-18, wherein the electrochemical system is configured for replacement of the metal anode. It should be understood that the metal anode can be in solid form, for example, metal particles. The metal anode can also be a liquid. Anode can thus be replaced by, for example, mechanical replacement, pumping, and other techniques.

Aspect 20. The electrochemical system of any one of Aspects 14-19, wherein the current collector, binder, separator, catholyte, and metal anode together define a total weight, and wherein the catholyte and metal anode define at least 85% of the total weight.

Aspect 21. The electrochemical system of Aspect 20, wherein the current collector, binder, separator, catholyte, and metal anode define at least 90% of the total weight.

Aspect 22. An electrochemical system, comprising: a refillable cell; a catholyte, the catholyte optionally being ionically conductive, and the catholyte optionally comprising at least one of dimethyl disulfide and dimethyl trisulfide; a metallic anode, the metallic anode optionally comprising Li; a cathode current collector configured to contact the catholyte; a polymeric separator disposed to separate the cathode current collector and the metallic anode; and optionally, a binder, and wherein the refillable cell is configured to contact the catholyte and the metallic anode so as to evolve current that is collected by the cathode current collector and to evolve a metallic reaction product, the metallic reaction product comprising a metal of the metallic anode and the metallic reaction product optionally being soluble in the catholyte, and wherein the refillable cell has an inlet configured to receive catholyte and has an outlet configured to communicate therefrom an output that comprises the metallic reaction product.

A cathode current collector can be, for example, configured for contact with the catholyte. A cathode current collector can be configured to be at least partially immersed in the catholyte.

A refillable cell can include, for example, an inlet for introduction of catholyte and an outlet. The outlet can be used, for example, for output of catholyte and the metallic reaction product. One or both of the inlet and the outlet can be sealable. A system can be configured to introduce catholyte at an inlet of the refillable cell while at the same time recovering catholyte from the outlet of the refillable cell.

Aspect 23. The electrochemical system of Aspect 22, wherein the catholyte comprises at least one of dimethyl trisulfide and dimethyl disulfide. The catholyte can be ionically conductive.

Aspect 24. The electrochemical system of any one of Aspects 21-23, wherein the metallic anode comprises Li.

Aspect 25. The electrochemical system of any one of Aspects 21-24, wherein the electrochemical system is comprised in a mobile device powered by the electrochemical system. The refillable cell can, for example, be removable from a device in which the refillable cell is installed.

Aspect 26. The electrochemical system of any one of Aspects 22-25, wherein the electrochemical system is configured for continuous refilling of catholyte.

Aspect 27. The electrochemical system of any one of Aspects 22-25, wherein the electrochemical system is configured for batch refilling of catholyte.

Aspect 28. The electrochemical system of any one of Aspects 22-27, wherein the electrochemical system is configured for replacement of the metallic anode. Without being bound to any particular theory or embodiment, a metallic anode can be sized such that the anode is sufficient to perform through several cycles of discharge and catholyte draining before the anode is replaced. For example, an anode can be filled at over-capacity so that one can discharge, drain, and refill the catholyte several times before refilling the anode.

Aspect 29. The electrochemical system of any one of Aspects 22-28, wherein the catholyte, metallic anode, cathode current collector, polymeric separator, and optional binder together define a total weight, and wherein the catholyte, the cathode current collector, and the metallic anode define at least 85% of the total weight. In this way, the active elements of the system define a significant portion of the system's weight, thereby conferring an advantageous per-weight efficiency on systems according to the present disclosure.

Aspect 30. The electrochemical system of Aspect 29, wherein the catholyte, the cathode current collector, and the metallic anode define at least 90% of the total weight.

Aspect 31. The electrochemical system of any one of Aspects 22-30, further comprising a cell configured to apply a current to the output that comprises the metallic reaction product.

Aspect 32. The electrochemical system of Aspect 31, wherein application of the current effects regeneration, from the output, of the catholyte and the metal of the metallic anode.

Aspect 33. A method, comprising: in a refillable cell, contacting (a) a catholyte and (b) a metallic anode under conditions sufficient to at least partially consume the metallic anode, evolve a current, and evolve a metallic reaction product, the metallic reaction product comprising a metal of the metallic anode and the metallic reaction product optionally being soluble in the catholyte, the catholyte optionally comprising at least one of dimethyl disulfide and trimethyl disulfide, and the metallic anode optionally comprising Li; and collecting the current. One can collect the current, for example, to power a device or other load.

Aspect 34. The method of Aspect 33, further comprising at least partially refilling the refillable cell with catholyte.

Aspect 35. The method of Aspect 34, wherein the refilling is performed in a continuous manner.

Aspect 36. The method of any one of Aspects 33-35, wherein the refilling is performed in a batch manner.

Aspect 37. The method of any one of Aspects 33-36, further comprising collecting an output that comprises the metallic reaction product and catholyte.

Aspect 38. The method of Aspect 37, further comprising applying a current to the output.

Aspect 39. The method of Aspect 38, wherein the current is applied so as to effect regeneration, from the output, of the catholyte and the metal of the metallic anode.

Aspect 40. The method of any one of Aspects 33-39, wherein the refillable cell comprises a catholyte, metallic anode, a cathode current collector, a polymeric separator, and optionally a binder that together define a total weight, and wherein the catholyte, the cathode current collector, and the metallic anode define at least 85% of the total weight.

Aspect 41. The method of Aspect 40, wherein the catholyte, the cathode current collector, and the metallic anode define at least 90% of the total weight.

1. An electrochemical system, comprising:
a refillable cell;
a catholyte,
the catholyte optionally being ionically conductive, and
the catholyte optionally comprising at least one of dimethyl disulfide and dimethyl trisulfide;
a metallic anode,
the metallic anode optionally comprising Li;
a cathode current collector configured to contact the catholyte;
a polymeric separator disposed to separate the cathode current collector and the metallic anode; and
optionally, a binder, and
wherein the refillable cell is configured to contact the catholyte and the metallic anode so as to evolve current that is collected by the cathode current collector and to evolve a metallic reaction product,
the metallic reaction product comprising a metal of the metallic anode and the metallic reaction product optionally being soluble in the catholyte, and
wherein the refillable cell has an inlet configured to receive catholyte and has an outlet configured to communicate therefrom an output that comprises the metallic reaction product.

2. The electrochemical system of claim 1, wherein the catholyte comprises at least one of dimethyl trisulfide and dimethyl disulfide.

3. The electrochemical system of claim 1, wherein the metallic anode comprises Li.

4. The electrochemical system of claim 1, wherein the electrochemical system is comprised in a mobile device powered by the electrochemical system.

5. The electrochemical system of claim 1, wherein the electrochemical system is configured for continuous refilling of catholyte.

6. The electrochemical system of claim 1, wherein the electrochemical system is configured for batch refilling of catholyte.

7. The electrochemical system of claim 1, wherein the electrochemical system is configured for replacement of the metallic anode.

8. The electrochemical system of claim 1, wherein the catholyte, metallic anode, cathode current collector, polymeric separator, and optional binder together define a total weight, and wherein the catholyte, the cathode current collector, and the metallic anode define at least 85% of the total weight.

9. The electrochemical system of claim 8, wherein the catholyte, the cathode current collector, and the metallic anode define at least 90% of the total weight.

10. The electrochemical system of claim 1, further comprising a cell configured to apply a current to the output that comprises the metallic reaction product.

11. The electrochemical system of claim 10, wherein application of the current effects regeneration, from the output, of the catholyte and the metal of the metallic anode.

12. A method, comprising:
in a refillable cell, contacting (a) a catholyte and (b) a metallic anode under conditions sufficient to at least partially consume the metallic anode, evolve a current, and evolve a metallic reaction product,
the metallic reaction product comprising a metal of the metallic anode and the metallic reaction product optionally being soluble in the catholyte,
the catholyte optionally comprising at least one of dimethyl disulfide and trimethyl disulfide, and
the metallic anode optionally comprising Li; and
collecting the current.

13. The method of claim 12, further comprising at least partially refilling the refillable cell with catholyte.

14. The method of claim 13, wherein the refilling is performed in a continuous manner.

15. The method of claim 13, wherein the refilling is performed in a batch manner.

16. The method of claim 12, further comprising collecting an output that comprises the metallic reaction product and catholyte.

17. The method of claim 16, further comprising applying a current to the output.

18. The method of claim 17, wherein the current is applied so as to effect regeneration, from the output, of the catholyte and the metal of the metallic anode.

19. The method of claim 12, wherein the refillable cell comprises a catholyte, metallic anode, a cathode current collector, polymeric separator, and optionally a binder that together define a total weight, and wherein the catholyte, the cathode current collector, and the metallic anode define at least 85% of the total weight.

20. The method of claim 19, wherein the catholyte, the cathode current collector, and the metallic anode define at least 90% of the total weight.
